(19) United States
(12) Patent Application Publication
(10) Pub. No.: US 2010/0220617 A1
(43) Pub. Date: Sep. 2, 2010

(54) Apparatus and method for detecting channel quality indicator information in wireless communication system

(75) Inventors: Young-Kwan Choi, Seoul (KR); Ha-Young Yang, Yongin-si (KR); Sung-Kwon Jo, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/660,363

(22) Filed: Feb. 25, 2010

(30) Foreign Application Priority Data
Feb. 27, 2009 (KR) 10-2009-0016681

(51) Int. Cl. H04L 12/26

(52) U.S. Cl. 370/252

(57) ABSTRACT

An apparatus and a method for a base station or a sector to efficiently detect Channel Quality Indicator (CQI) information transmitted from a terminal in a wireless communication system are provided. A method of a base station for detecting CQI information in a wireless communication system includes determining a part or all of a CQI interval as a correlation interval based at least partly upon a presence of an interference power less than a threshold in a corresponding interval of the CQI interval; and determining correlations between a signal received over the determined correlation interval and possible codewords.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Feb. 27, 2009 and assigned Serial No. 10-2009-0016681, the entire disclosure of which is hereby incorporated by reference.

### TECHNICAL FIELD OF THE INVENTION

The present invention relates generally to an apparatus and a method for a base station or a sector to efficiently detect Channel Quality Indicator (CQI) information transmitted from a terminal in a wireless communication system. More particularly, the present invention relates to an apparatus and a method for efficiently detecting CQI information transmitted from a terminal when one or more base stations or sectors supporting a Time Division Duplex (TDD) service use different DownLink/UpLink (DL/UL) symbol rates in a wireless communication system.

### BACKGROUND OF THE INVENTION

In a rapid wireless communication system, a base station schedules transfer of packet data and determines transmission parameters using Channel Quality Indicator (CQI) information indicating quality of a forward channel, and thus carries out a rapid packet data service. That is, the base station transmits the packet data by selecting terminals of the best forward channel quality in every slot among a plurality of terminals communicating, and determines the transmission parameters, e.g., a data rate, a code rate, and a modulation order according to the forward channel quality of the selected terminals.

The CQI information is not a considerable amount but delivers very important data for the communication system operation. Hence, the CQI information needs guaranteed high reliability in its transmission. However, to reduce an overhead rate, a limited amount of frequency-time axis resources are generally allocated to a physical channel for sending the CQI information. Thus, an efficient detection method is required for the reliable transmission of the CQI information.

In a conventional wireless communication system, the CQI information detecting method of the base station is explained. The base station receives the received symbols over a CQI interval for detecting the CQI information in the frame, determines a soft decision value, and detects a codeword using the determined soft decision value. Next, the base station determines the detected codeword as the information data transmitted from the terminal, and detects the CQI information using the determined information data.

The above CQI information detecting method works efficiently in a general communication environment, but greatly degrades efficiency when an interference signal greater than a threshold exists in part of the CQI interval. For example, two base stations supporting a Time Division Duplex (TDD) service can use different DownLink/UpLink (DL/UL) symbol rates. Since the DL/UL symbol rate is not fixed to one value but varies according to the management of a provider, this example can happen in the actual operation.

FIG. 1 shows a frame structure when two base stations supporting the TDD service use different DL/UL symbol rates in the conventional wireless communication system.

In FIG. 1, the frame of the base station A and the base station B supporting the TDD service includes DL intervals 100 and 110 and UL intervals 106 and 114. A Guard Time (GT) 102, 108, 112 and 116 is inserted between the DL intervals 100 and 110 and the UL intervals 106 and 114 and between the UL intervals 106 and 114 and the DL intervals 100 and 110. A CQI interval 104 precedes the UL interval 106, and a CQI interval (not shown) can precede the UL interval 114.

Herein, since the base station A and the base station B utilize the different DL/UL symbol rates, the DL interval 100 of the base station A ends and then the UL interval 106 starts. When a service terminal of the base station A transmits the CQI information to the base station A in the CQI interval 104, the base station B sends a DL signal over part of the CQI interval 104 because the DL interval 110 does not yet end. The DL signal acts as an interference signal in the CQI information detection of the base station A. As a result, when the base station A attempts to detect the CQI information, the detection performance is seriously hindered.

### SUMMARY OF THE INVENTION

To address the above-discussed deficiencies of the prior art, it is a primary aspect of the present invention is to address at least the above mentioned problems and/or disadvantages and to provide at least the advantages described below. Accordingly, an aspect of the present invention is to provide an apparatus and a method for a base station or a sector to efficiently detect Channel Quality Indicator (CQI) information transmitted from a terminal in a wireless communication system.

Another aspect of the present invention is to provide an apparatus and a method for efficiently detecting CQI information transmitted from a terminal when one or more base stations or sectors supporting a Time Division Duplex (TDD) service using different DownLink/UpLink (DL/UL) symbol rates in a wireless communication system.

Yet another aspect of the present invention is to provide an apparatus and a method for a base station or a sector to detect CQI information transmitted from a terminal over a CQI interval excluding a partial interval of the CQI interval when an interference signal greater than a threshold exists in the partial interval of the CQI interval in a wireless communication system.

According to one aspect of the present invention, a method of a base station for detecting CQI information in a wireless communication system includes determining a part or all of a CQI interval as a correlation interval based at least partly upon a presence of an interference power less than a threshold in a corresponding interval of the CQI interval; and determining correlations between a signal received over the determined correlation interval and possible codewords.

According to another aspect of the present invention, an apparatus of a base station for detecting CQI information in a wireless communication system includes a correlation interval determiner configured to determine a part or all of a CQI interval as a correlation interval based at least partly upon a presence of an interference power less than a threshold in a corresponding interval of the CQI interval; and a correlator configured to determine correlations between a signal received over the determined correlation interval and possible codewords.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram of a frame structure when two base stations supporting a TDD service use different DL/UL symbol rates in a conventional wireless communication system;

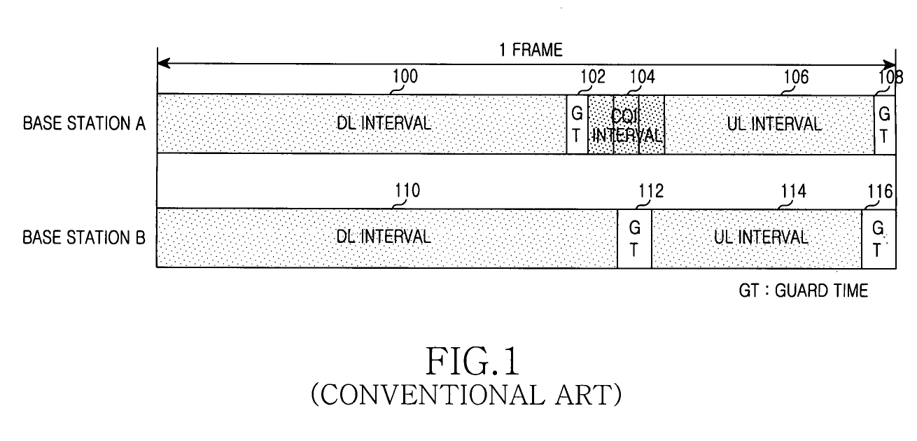

FIG. 2 illustrates a CQI information detecting apparatus of a base station in a wireless communication system according to an exemplary embodiment of the present invention;

FIG. 3 illustrates a CQI information detecting method of a base station in a wireless communication system according to an exemplary embodiment of the present invention;

FIG. 4 illustrates a CQI interval determining method of a base station in a wireless communication system according to one exemplary embodiment of the present invention; and

FIG. 5 illustrates a CQI interval determining method of a base station in a wireless communication system according to another exemplary embodiment of the present invention.

Throughout the drawings, like reference numerals will be understood to refer to like parts, components and structures.

### DETAILED DESCRIPTION OF THE INVENTION

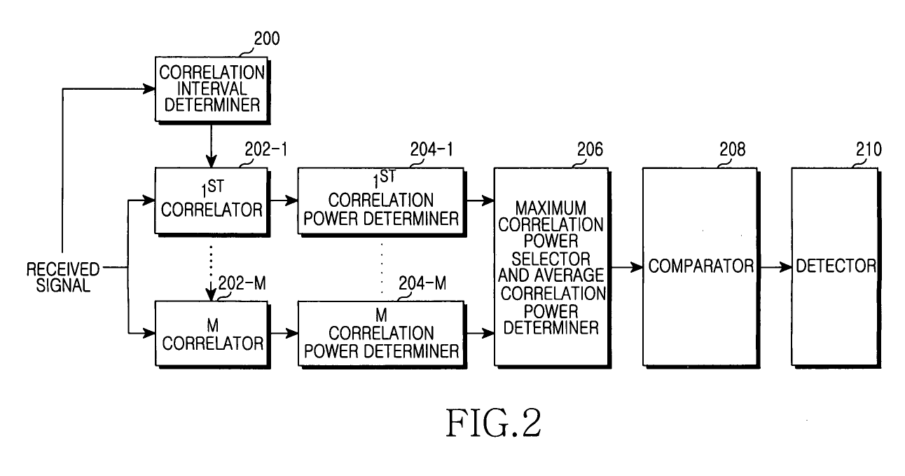

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present invention provide an apparatus and a method for a base station or a sector to detect CQI information transmitted from a terminal over a CQI interval excluding a partial interval of CQI interval when an interference signal greater than a threshold exists in the partial interval of the CQI interval in a wireless communication system. Hereinafter, the base station is exemplified.

FIG. 2 illustrates a CQI information detecting apparatus of a base station in a wireless communication system according to an exemplary embodiment of the present invention. Hereinafter, a case of M-ary codewords transmittable by a terminal is exemplified.

The CQI information detecting apparatus of the base station includes a correlation interval determiner 200, first through M correlators 202-1 through 202-M, first through M correlation power determiners 204-1 through 204-M, a maximum correlation power selector and average correlation power determiner 206, a comparator 208, and a detector 210.

Referring to FIG. 2, the correlation interval determiner 200 determines a correlation interval to an interval including an allowable interference signal in the CQI interval, and outputs information relating to the determined correlation interval to the first through M correlators 202-1 through 202-M.

The first through M correlators 202-1 through 202-M determine correlations between a signal received from the terminal over the determined correlation interval and the transmittable codewords, and output the determined correlations to the first through M correlation power determiners 204-1 through 204-M. The first correlator 202-1 determines the correlation between the signal received over the determined correlation interval and the signal corresponding to the first codeword of the M-ary codewords transmittable by the terminal, and outputs the determined correlation to the first correlation power determiner 204-1. The M correlator 202-M determines the correlation between the signal received over the determined correlation interval and the signal corresponding to the M-th codeword of the M-ary codewords transmittable by the terminal, and outputs the determined correlation to the M correlation power determiner 204-M.

The first through M correlation power determiners 204-1 through 204-M determine the power of each correlation determined, and output the determined power of each correlation to the maximum correlation power selector and average correlation power determiner 206. More specifically, the first correlation power determiner 204-1 determines the power of the correlation output from the first correlator 202-1, and outputs the determined correlation power to the maximum correlation power selector and average correlation power determiner 206. The M correlation power determiner 204-M determines the power of the correlation output from the M correlator 202-M, and outputs the determined correlation power to the maximum correlation power selector and average correlation power determiner 206.

The maximum correlation power selector and average correlation power determiner 206 selects a maximum correlation power of the maximum power value among the determined correlation powers, determines an average correlation power of the determined correlation powers, and outputs the selected maximum correlation power and the determined average correlation power to the comparator 208.

The comparator 208 determines a difference value of the selected maximum correlation power and the determined average correlation power and determines whether the acquired difference is greater than a threshold. When the acquired difference is greater than the threshold, the comparator 208 outputs the selected maximum correlation power to the detector 210. When the acquired difference is not greater than the threshold, the comparator 208 discards the received signal.

The detector 210 detects the transmittable codeword corresponding to the selected maximum correlation power, determines the detected codeword as information data, and detects the CQI information using the determined information data.

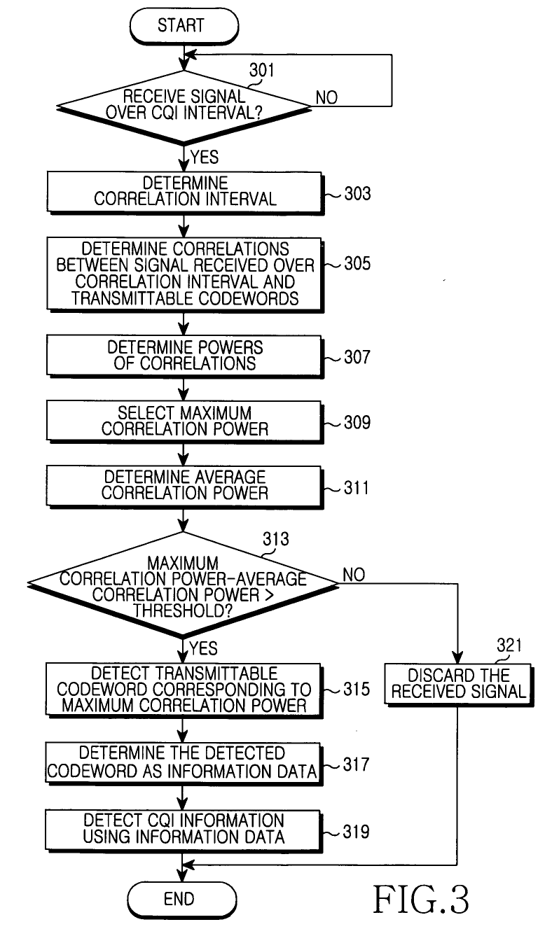

FIG. 3 is a flowchart of a CQI information detecting method of the base station in the wireless communication system according to an exemplary embodiment of the present invention.

In step 301, the base station determines whether a signal is received from the terminal over the CQI interval.

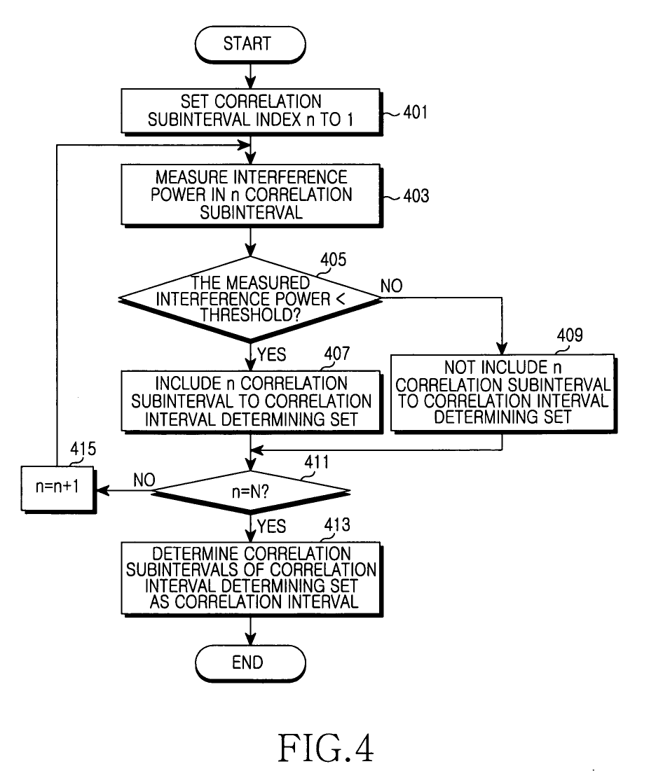

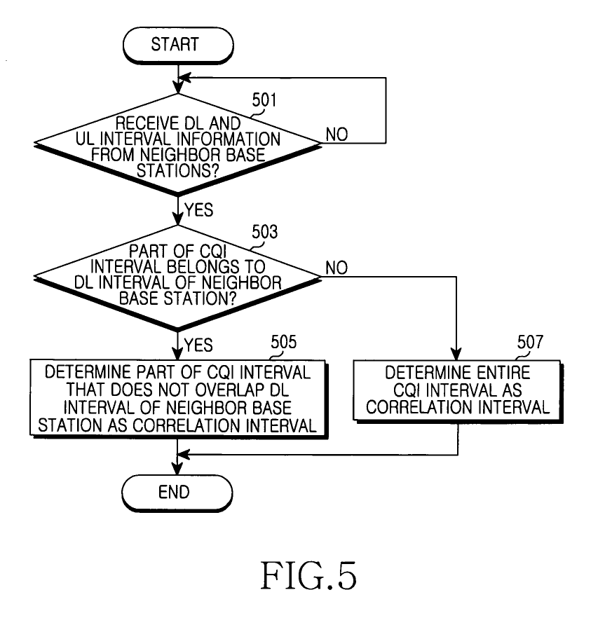

Upon receiving the signal from the terminal over the CQI interval in step 301, the base station determines the correlation interval to the interval including the allowable interference signal in the CQI interval in step 303. Herein, the method for determining the correlation interval shall be described in detail by referring to FIGS. 4 and 5.

In step 305, the base station determines the correlations between the signal received over the determined correlation interval and the transmittable codewords. When there are M-ary codewords transmittable by the terminal, the base station determines the correlations between the signal received over the determined correlation interval and the M-ary codewords.

Next, the base station determines the powers of the determined correlations in step 307 and selects the maximum correlation power of the maximum power value among the determined correlation powers in step 309. In step 311, the base station determines the average correlation power of the determined correlation powers.

In step 313, the base station determines the difference between the selected maximum correlation power and the determined average correlation power and determines whether the determined difference is greater than the threshold.

When the determined difference is greater than the threshold in step 313, the base station determines that the reliability of determining the transmittable codeword corresponding to the selected maximum correlation power as the information data is above a reference value due to an acceptable communication environment, and detects the transmittable codeword corresponding to the selected maximum correlation power in step 315. Next, the base station determines the detected codeword as the information data in step 317 and detects the CQI information using the determined information data in step 319.

By contrast, when the determined difference is not greater than the threshold in step 313, the base station determines that the reliability of determining the transmittable codeword corresponding to the selected maximum correlation power as the information data is below the reference value due to a poor communication environment, and discards the received signal in step 321.

Herein, the CQI information detecting method of the base station can be expressed as Equation 1 below:

$$\begin{matrix}max \\ m\end{matrix} {\vert {\int }_{= 0}^{{T}_{P}} \begin{matrix}{X}_{m} ( t ) \\ Y ( t )\end{matrix} \vert}^{2} - \begin{matrix}avrg \\ m\end{matrix} {\vert {\int }_{= 0}^{{T}_{P}} \begin{matrix}{X}_{m} ( t ) \\ Y ( t )\end{matrix} \vert}^{2} \begin{matrix}> Threshold \to Detect \\ < Threshold \to Erase\end{matrix} \vert . \qquad [ Eqn . 1 ]$$

In Equation 1, Y(t) denotes the received signal and Xₘ(t) denotes a signal corresponding to the m-th (herein, m=1, . . . , M) codeword of the M-ary possible codewords. Tₚ, which is the correlation interval, denotes the interval including the allowable interference signal in the CQI interval. Tₚ is smaller than or equal to the CQI interval in size.

Next, the base station finishes this process.

FIG. 4 illustrates a CQI interval determining method of a base station in a wireless communication system according to one exemplary embodiment of the present invention.

In step 401, the base station divides the CQI interval into N-ary correlation subintervals and initially sets a correlation subinterval index n to 1. A correlation interval determining set is defined to determine the interval including the allowable interference signal in the CQI interval as the correlation interval, and is initialized to the empty set.

The base station measures the interference power in the n correlation subinterval in step 403 and determines whether the measured interference power is less than a threshold in step 405.

When the measured interference power is less than the threshold in step 405, the base station includes the n correlation subinterval to the correlation interval determining set in step 407. By contrast, when the measured interference power is not less than the threshold in step 405, the base station does not include the n correlation subinterval to the correlation interval determining set in step 409.

In step 411, the base station examines whether n is equal to the number of the correlation subintervals N. When n is equal to the number of correlation the subintervals N in step 411, the base station determines that the interference power of every correlation subinterval has been compared with the threshold and determines the correlation subintervals of the correlation interval determining set as the correlation interval in step 413. By contrast, when n is not equal to the number of the correlation subintervals N in step 411, the base station increments n by 1 in step 415 and returns to step 403 to repeat the subsequent steps.

Next, the base station finishes this process.

FIG. 5 is a flowchart of a CQI interval determining method of the base station in the wireless communication system according to another exemplary embodiment of the present invention.

In step 501, the base station determines whether the information of the DL and UL intervals is received from neighbor base stations. Herein, the information of the DL and UL intervals can be, for example, the DL/UL symbol rate. The neighbor base stations can receive the information of the DL and UL intervals from their upper controller which controls the neighbor base stations.

In step 503, the base station determines whether a part of the CQI interval overlaps a DL interval of a neighbor base station.

When part of the CQI interval belongs to a DL interval of a neighbor base station in step 503, the base station determines a part of the CQI interval that does not overlap the DL interval of the neighbor base station as the correlation interval in step 505.

By contrast, when part of the CQI interval does not belong to the DL interval of the neighbor base station in step 503, the base station determines the entire CQI interval as the correlation interval in step 507.

Next, the base station finishes this process.

As set forth above, when the base station or the sector detects the CQI information transmitted from the terminal and part of the CQI interval includes the interference signal greater than the threshold in the wireless communication system, the CQI information is detected over the part of the CQI interval that does not includes the interference signal. Therefore, the influence of the interference signal can be mitigated efficiently, and the CQI information detection performance can be enhanced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of a base station for detecting Channel Quality Indicator (CQI) information in a wireless communication system, the method comprising:
determining a part or all of a CQI interval as a correlation interval based at least partly upon a presence of an interference power less than a threshold in a corresponding interval of the CQI interval; and
determining correlations between a signal received over the determined correlation interval and possible codewords.

2. The method of claim 1, further comprising:
determining correlation powers for each of the determined correlations;
selecting a maximum correlation power from the determined correlation powers;
determining an average correlation power of the determined correlation powers;
determining a difference between the selected maximum correlation power and the determined average correlation power;
comparing the determined difference with a threshold;
when the determined difference is greater than the threshold, detecting a codeword corresponding to the selected maximum correlation power and detecting CQI information using the detected codeword; and
when the determined difference is not greater than the threshold, discarding the received signal.

3. The method of claim 1, wherein the determining of the correlation interval comprises:
dividing the CQI interval into a plurality of correlation subintervals;
measuring an interference power in a corresponding interval for each correlation subinterval;
including a correlation subinterval having an interference power measured in the corresponding interval that is less than a threshold in the divided correlation subintervals to a correlation interval determining set; and
determining correlation subintervals in the correlation interval determining set as the correlation interval.

4. The method of claim 1, wherein the determining of the correlation interval comprises:
receiving information relating to DownLink (DL) and UpLink (UL) intervals from neighbor base stations;
determining whether a part of the CQI interval overlaps a DL interval of a neighbor base station;
when part of the CQI interval overlaps a DL interval of a neighbor base station, determining a part of the CQI interval that does not overlap the DL interval of the neighbor base station as the correlation interval; and
when part of the CQI interval does not belong to the DL interval of the neighbor base station, determining the entire CQI interval as the correlation interval.

5. The method of claim 4, wherein the information relating to the DL and UL intervals is a DL/UL symbol rate.

6. An apparatus of a base station for detecting Channel Quality Indicator (CQI) information in a wireless communication system, the apparatus comprising:
a correlation interval determiner configured to determine a part or all of a CQI interval as a correlation interval based at least partly upon a presence of an interference power less than a threshold in the CQI interval; and
a correlator configured to determine correlations between a signal received over the determined correlation interval and possible codewords.

7. The apparatus of claim 6, further comprising:
a correlation power determiner configured to determine a correlation power for each of the determined correlations;
a maximum correlation power selector and average correlation power determiner configured to select a maximum correlation power from the determined correlation powers and determine an average correlation power of the determined correlation powers;
a comparator configured to determine a difference between the selected maximum correlation power and the determined average correlation power, to compare the determined difference with a threshold, output the selected maximum correlation power when the determined difference is greater than the threshold, and discard the received signal when the determined difference is not greater than the threshold; and
a detector configured to detect a codeword corresponding to the maximum correlation power received from the comparator and detect CQI information using the detected codeword.

8. The apparatus of claim 6, wherein the correlation interval determiner comprises:
a means for dividing the CQI interval into a plurality of correlation subintervals;
a means for measuring an interference power in a corresponding interval for each correlation subinterval;
a means for including a correlation subinterval having the interference power measured in the corresponding interval that is less than a threshold in the divided correlation subintervals to a correlation interval determining set; and
a means for determining correlation subintervals of the correlation interval determining set as the correlation interval.

9. The apparatus of claim 6, wherein the correlation interval determiner comprises:
a means for receiving information relating to DownLink (DL) and UpLink (UL) intervals from neighbor base stations;
a means for determining whether a part of the CQI interval overlaps a DL interval of a neighbor base station;
when a part of the CQI interval overlaps a DL interval of a neighbor base station, a means for determining a part of the CQI interval that does not overlap the DL interval of the neighbor base station as as the correlation interval; and
when a part of the CQI interval does not overlap a DL interval of a neighbor base station, a means for determining the entire CQI interval as the correlation interval.

10. The apparatus of claim 9, wherein the information relating to the DL and UL intervals is a DL/UL symbol rate.

11. A method comprising:
dividing a CQI interval into a plurality of correlation subintervals;
measuring an interference power in a corresponding interval for each correlation subinterval;
when a correlation subinterval has an interference power that is less than a threshold, add the correlation subinterval to a correlation interval determining set;
determining correlation subintervals in the correlation interval determining set as a correlation interval; and
determining correlations between a signal received over the determined correlation interval and possible codewords.

12. The method of claim 11, further comprising:
determining correlation powers for each of the determined correlations;
selecting a maximum correlation power from the determined correlation powers;
determining an average correlation power of the determined correlation powers;
determining a difference between the selected maximum correlation power and the determined average correlation power;
comparing the determined difference with a threshold;
when the determined difference is greater than the threshold, detecting a codeword corresponding to the selected maximum correlation power and detecting CQI information using the detected codeword; and
when the determined difference is not greater than the threshold, discarding the received signal.

13. The method of claim 11, wherein determining correlation subintervals in the correlation interval determining set as a correlation interval comprises:
receiving information relating to DownLink (DL) and UpLink (UL) intervals from neighbor base stations;
determining whether a part of the CQI interval overlaps a DL interval of a neighbor base station;
when part of the CQI interval overlaps a DL interval of a neighbor base station, determining a part of the CQI interval that does not overlap the DL interval of the neighbor base station as the correlation interval; and
when part of the CQI interval does not belong to the DL interval of the neighbor base station, determining the entire CQI interval as the correlation interval.

14. The method of claim 13, wherein the information relating to the DL and UL intervals is a DL/UL symbol rate.

15. An apparatus comprising:
a means for dividing a CQI interval into a plurality of correlation subintervals;
a means for measuring an interference power in a corresponding interval for each correlation subinterval;
when a correlation subinterval has an interference power that is less than a threshold, a means for adding the correlation subinterval to a correlation interval determining set;
a means for determining correlation subintervals in the correlation interval determining set as the correlation interval; and
a means for determining correlations between a signal received over the determined correlation interval and possible codewords.

16. The apparatus of claim 15, further comprising:
a correlation power determiner configured to determine a correlation power for each of the determined correlations;
a maximum correlation power selector and average correlation power determiner configured to select a maximum correlation power from the determined correlation powers and determine an average correlation power of the determined correlation powers;
a comparator configured to determine a difference between the selected maximum correlation power and the determined average correlation power, to compare the determined difference with a threshold, output the selected maximum correlation power when the determined difference is greater than the threshold, and discard the received signal when the determined difference is not greater than the threshold; and
a detector configured to detect a codeword corresponding to the maximum correlation power received from the comparator and detect CQI information using the detected codeword.

17. The apparatus of claim 16, wherein the correlation interval determiner comprises:
a means for receiving information relating to DownLink (DL) and UpLink (UL) intervals from neighbor base stations;
a means for determining whether a part of the CQI interval overlaps a DL interval of a neighbor base station;
when a part of the CQI interval overlaps a DL interval of a neighbor base station, a means for determining a part of the CQI interval that does not overlap the DL interval of the neighbor base station as as the correlation interval; and
when a part of the CQI interval does not overlap a DL interval of a neighbor base station, a means for determining the entire CQI interval as the correlation interval.

18. The apparatus of claim 17, wherein the information relating to the DL and UL intervals is a DL/UL symbol rate.
